(19) United States
(12) Patent Application Publication
(10) Pub. No.: US 2003/0053768 A1
(43) Pub. Date: Mar. 20, 2003

(54) Fiber optic transceiver, connector, and method of dissipating heat

(75) Inventors: Johnny R. Brezina, Austin, TX (US); Brian M. Kerrigan, Austin, TX (US); Gerald D. Malagrino JR., Rochester, MN (US); James R. Moon, Oronoco, MN (US); Hoa T. Phan, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/956,771

(22) Filed: Sep. 20, 2001

(51) Int. Cl. G02B 6/42

(52) U.S. Cl. 385/92; 359/152

(57) ABSTRACT

The present invention provides a fiber optic transceiver assembly, a fiber optic connector assembly for receiving a fiber optic cable, and a method of dissipating heat in a fiber optic transceiver. The fiber optic transceiver assembly includes a connector housing and a heat sink operably attached to the connector housing. Heat generated within the connector housing is dissipated through both the connector housing and the heat sink. The fiber optic connector assembly includes a first housing member including a socket formed therein, a latch arm assembly positioned adjacent the socket, and a second housing member operably attached to the first housing member. The latch arm assembly is retained by the first and second housing members. The method of dissipating heat in the fiber optic transceiver includes attaching a heat sink to a connector housing and transferring heat generated by the fiber optic connector through both the connector housing and the heat sink.

### TECHNICAL FIELD OF THE INVENTION

The present invention relates generally to computer systems and in particular to fiber optic transceivers.

### BACKGROUND OF THE INVENTION

Numerous considerations are made in the design strategy of modern optical devices. The increasing electronic integration and higher functionality of the optical devices and associated electronic chipsets tend to require greater power and higher wattage. Thus, one design consideration is the abundance of thermal energy produced during device operation. The high wattage and thermal density in these devices demands an efficient cooling strategy. Another consideration is the thermal limits imposed on the optical devices and associated electronic chipsets located in close proximity.

Multiple array optical transceivers are examples of optical devices requiring enhanced thermal energy dissipation. To achieve two-way communication, multiple array optical transceivers couple discrete laser light paths into external fibers and, conversely, couple light from external discrete fibers back to respective photodetectors. Heat is generated by this coupling process. In addition, thermal energy is produced by electronic signals as they pass through conductors and as the signals are processed by solid-state chips within the transceivers. Thus, thermal issues may limit data processing speed, signal carrying capacity, and reliability of current transceiver designs if not properly considered. As transceivers become more sophisticated, more efficient cooling strategies are required to permit unit operation.

Strategies for providing a cooling mechanism in transceiver devices are known. For example, a heat sink may typically be placed on or near the transceiver to achieve cooling. The use of a simple heat sink or other cooling strategies, however, may not provide sufficient cooling for advanced and also reduced size transceiver designs and their high wattage and thermal densities. Furthermore, those strategies providing adequate heat removal may require numerous and complex parts increasing manufacturing time and expense.

Another consideration in transceiver design pertains to the connection of a standard fiber optic cable. The fiber optic cable is typically attached to the transceiver through a snap-in or latch-type spring arm connector. The connector, however, may be attached to the transceiver with the aid of additional fastening components thereby increasing manufacturing time and expense.

Therefore, it would be desirable to have a fiber optic transceiver, a system for attaching a fiber optic cable, and a method for cooling the same that overcomes the aforementioned and other disadvantages.

### SUMMARY OF THE INVENTION

One aspect of the present invention provides a fiber optic transceiver assembly including a connector housing and a heat sink operably attached to the connector housing. Heat generated within the connector housing is dissipated through both the connector housing and the heat sink. A latch arm assembly may be operably attached to the connector housing for retaining a fiber optic cable. The latch arm assembly may be retained between a first connector housing portion mated to a second connector housing portion. The latch arm assembly may comprise a molded plastic material. The connector housing may comprise a thermally conductive material. The thermally conductive material may comprise aluminum. The heat sink may comprise a pin fin arrangement.

Another aspect of the present invention provides a fiber optic connector assembly for receiving a fiber optic cable including a first housing member including a socket formed therein, a latch arm assembly positioned adjacent the socket, and a second housing member operably attached to the first housing member. The latch arm assembly is retained by the first and second housing members. A heat sink may be operably attached to at least one housing member wherein heat generated within the connector assembly is dissipated through at least one housing member and the heat sink. The heat sink may comprise a pin fin arrangement. The latch arm assembly may comprise a molded plastic material. At least one housing member may comprise a thermally conductive material. The thermally conductive material may comprise aluminum.

Another aspect of the present invention provides a method of dissipating heat in the fiber optic transceiver. A heat sink is attached to a connector housing. Heat generated by the fiber optic connector is transferred through both the connector housing and the heat sink. A latch arm assembly may be attached to the connector housing for retaining a fiber optic cable. The latch arm assembly may be retained between a first connector housing portion mated to a second connector housing portion. The latch arm assembly may comprise a molded plastic material. The connector housing may comprise a thermally conductive material. The thermally conductive material may comprise aluminum. The heat sink may comprise a pin fin arrangement.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows an isometric diagram of a fiber optic transceiver assembly made in accordance with the present invention;

FIGS. 2A & 2B show isometric diagrams of a partially assembled fiber optic transceiver assembly made in accordance with the present invention; and

FIG. 3 shows an isometric diagram of a partially assembled fiber optic transceiver assembly and attached fiber optic cable made in accordance with the present invention.

### DETAILED DESCRIPTION OF THE PRESENTLY PREFERRED EMBODIMENTS

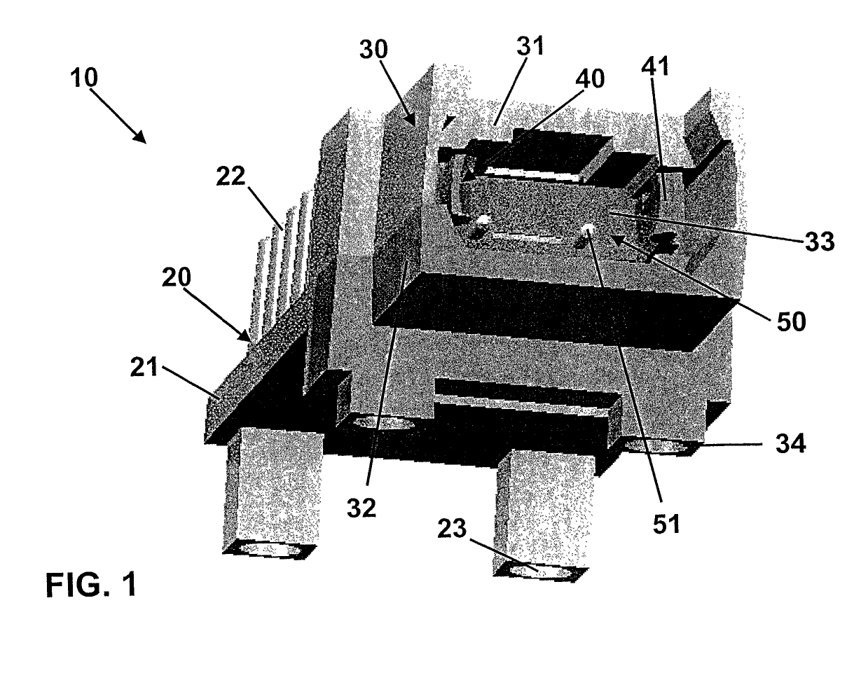

Referring to the drawings, FIG. 1 shows an isometric diagram of a fiber optic transceiver assembly made in accordance with the present invention. The fiber optic transceiver assembly is designated in the aggregate as numeral 10. The fiber optic transceiver assembly 10 includes a connector housing 30 and a heat sink 20 operably attached to the connector housing.

The fiber optic transceiver assembly 10 may further include laser/photodetector components and associated circuitry (not shown) performing light-to-electronic and electronic-to-light conversion. In one embodiment, the optical converters may be lasers only, so that the transceiver only transmits optical signals. In another embodiment, the optical converters may be photodetectors only, so that the transceiver only receives optical signals. In other embodiments, the number of lasers and photodetectors may be varied to meet the number of transmit and receive channels desired.

The heat sink 20 may be die cast and include a base 21 and cooling elements 22 comprised of columnar structures arranged in a pin fin arrangement. The cooling elements are generally designed to provide increased surface area thereby maximizing heat dissipation. In other embodiments, the heat sink may include alternatively arranged pins, fins, vanes, passive cooling elements, active cooling elements, or combinations thereof. The heat sink 20 may be secured to a customer board (not shown) by passing two screws (not shown) through specified hole locations in the board backside and into heat sink mounting screw locations 23. The heat sink 20 and connector housing 30 may be manufactured from a thermally conductive material. The thermally conductive material may be any sufficiently rigid material with good thermal conductivity, such as copper, steel, or, more preferably, aluminum.

The connector housing 30 may include a first housing member 31 including a socket 33 formed therein. A latch arm assembly 40 may be positioned adjacent the socket 33. The latch arm assembly 40 may be manufactured from a molded plastic material and include two spring arms 41 connected by a transverse portion. The use of a plastic material for the spring arms 41 provides the flexibility needed for a fiber optic cable “snap-in” connection. A second housing member 32 may be operably attached to the first housing member 31 through a mated connection.

In one embodiment, the first and second housing members 31, 32 may be joined with “roll” pins (not shown). In another embodiment, the first and second housing members 31, 32 may be joined with a tongue-and-groove positioned along opposing member edges. In yet another embodiment, the second housing member 32 may be attached to the first housing member 31 with two screws (not shown). The two screws may also structurally anchor the transceiver assembly 10 to the customer board by passing the screws through specified hole locations in the board backside and into two housing mounting screw locations 34.

In one embodiment, an optical lens assembly 50 may be positioned within the connector housing 30 and attached by thermal epoxy. Precise positioning may provide efficient optical signal transfer between the optical lens assembly 50, optical elements, and fiber optic cable. The optical lens assembly 50 may include a pair of positioning pins 51 to provide a degree of alignment between the lens assembly and the fiber optic cable.

In operation of the fiber optic transceiver assembly 10, heat generated within the connector housing 30 is dissipated through both the connector housing and the heat sink 20. Manufacturing both the attached heat sink 20 and the connector housing 30 from a uniform thermally conductive material provides a thermally efficient design, since heat generated within the assembly 10 may be dissipated through two distinct heat paths. Specifically, heat may be dissipated in one direction through the heat sink 20, in an opposite direction through the connector housing 30, and thru the second housing member 32 eventually to the rear panel of the customer machine.

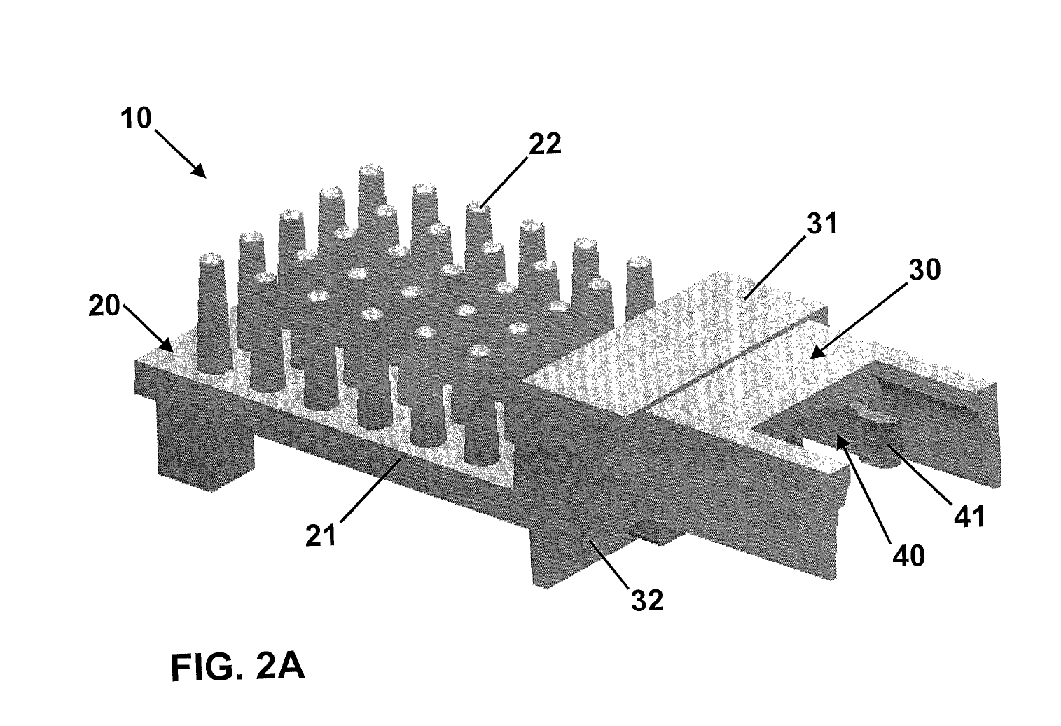

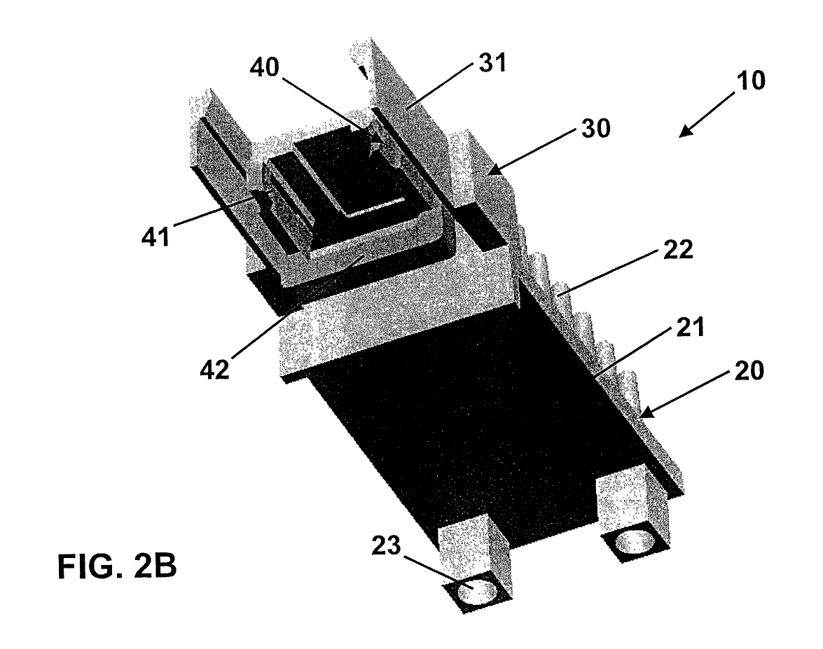

FIGS. 2A & 2B, in which like elements have like reference numerals, show isometric diagrams of a partially assembled fiber optic transceiver assembly made in accordance with the present invention. The transceiver assembly 10 is shown without an attached second housing member 32 to provide an alternative view of the socket 33 and latch arm assembly 40 including transverse portion 42 positioned therein. The latch arm assembly 40 may be retained by the first and second housing members 31, 32. Specifically, the latch arm assembly 40 may be positioned in the socket 33 and retained after the second housing member 32 is attached to the first housing member 31. Attaching the latch arm assembly in this “trapping” manner eliminates the need for additional fastening components and may reduce manufacturing time and expense.

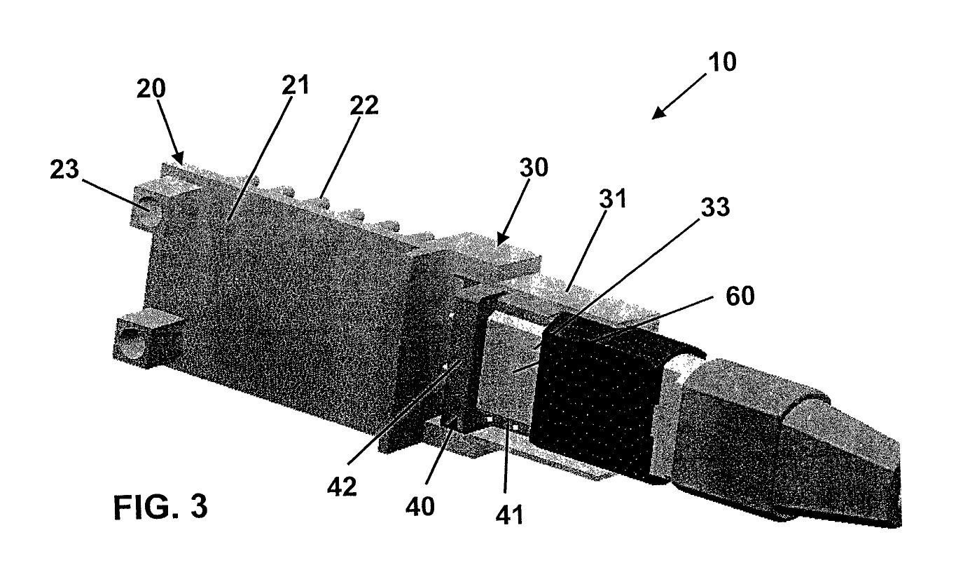

FIG. 3 shows an isometric diagram of a partially assembled fiber optic transceiver assembly and attached fiber optic cable 60 made in accordance with the present invention. In one embodiment, the fiber optic cable 60 may be a standard MTP-type cable known in the art. The connector housing socket 33 is generally designed to accept the fiber optic cable. Discrete fibers (not shown) within the fiber optic cable 60 may align with individual lenses in the optical lens assembly permitting coupling to the laser/photodetector components. An EMI assembly clip (not shown) may be slid over the first and second housing members 31, 32 after attaching the fiber optic cable 60. In one embodiment, the EMI assembly clip may provide a means of securing the second housing member 32 to the first housing member 31. The EMI assembly clip may provide both EMI and group connection points to a customer chassis bulkhead (not shown).

It is important to note that the figures and description illustrate specific applications and embodiments of the present invention, and is not intended to limit the scope of the present disclosure or claims to that which is presented therein. While the figures and description present a 4-channel transmit and 4-channel receive multiple array transceiver, the present invention is not limited to that format, and is therefore applicable to other array formats including dedicated transceiver modules, dedicated receiver modules, and modules with different numbers of channels. Furthermore, the heat sink and connector housing may be configured in alternative geometric configurations or arrangements to provide efficient heat dissipation characteristics. Upon reading the specification and reviewing the drawings hereof, it will become immediately obvious to those skilled in the art that a myriad of other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A fiber optic transceiver assembly comprising;
a connector housing; and
a heat sink operably attached to the connector housing wherein heat generated within the connector housing is dissipated through both the connector housing and the heat sink.

2. The assembly of claim 1 further comprising:
a latch arm assembly operably attached to the connector housing for retaining a fiber optic cable.

3. The assembly of claim 2 wherein the latch arm assembly is retained between a first connector housing portion mated to a second connector housing portion.

4. The assembly of claim 2 wherein the latch arm assembly comprises a molded plastic material.

5. The assembly of claim 1 wherein the connector housing comprises a thermally conductive material.

6. The assembly of claim 5 wherein the thermally conductive material comprises aluminum.

7. The assembly of claim 1 wherein the heat sink comprises a pin fin arrangement.

8. A fiber optic connector assembly for receiving a fiber optic cable comprising;
a first housing member including a socket formed therein;
a latch arm assembly positioned adjacent the socket; and
a second housing member operably attached to the first housing member, wherein the latch arm assembly is retained by the first and second housing members.

9. The assembly of claim 8 further comprising:
a heat sink operably attached to at least one housing member wherein heat generated within the connector assembly is dissipated through at least one housing member and the heat sink.

10. The assembly of claim 9 wherein the heat sink comprises a pin fin arrangement.

11. The assembly of claim 8 wherein the latch arm assembly comprises a molded plastic material.

12. The assembly of claim 8 wherein at least one housing member comprises a thermally conductive material.

13. The assembly of claim 12 wherein the thermally conductive material comprises aluminum.

14. A method of dissipating heat in a fiber optic transceiver comprising:
attaching a heat sink to a connector housing; and
transferring heat generated by the fiber optic transceiver through both the connector housing and the heat sink.

15. The method of claim 14 further comprising:
attaching a latch arm assembly to the connector housing for retaining a fiber optic cable.

16. The method of claim 15 further comprising:
retaining the latch arm assembly between a first connector housing portion mated to a second connector housing portion.

17. The method of claim 15 wherein the latch arm assembly comprises a molded plastic material.

18. The method of claim 14 wherein the connector housing comprises a thermally conductive material.

19. The method of claim 18 wherein the thermally conductive material comprises aluminum.

20. The method of claim 14 wherein the heat sink comprises a pin fin arrangement.
